(19) United States
(12) Patent Application Publication
(10) Pub. No.: US 2003/0103458 A1
(43) Pub. Date: Jun. 5, 2003

(54) Congestion avoidance apparatus and method for communication network

(75) Inventor: Young-Soo Shin, Seongnam (KR)

Correspondence Address: FLESHNER & KIM, LLP, P.O. BOX 221200, CHANTILLY, VA, 20153, US

(73) Assignee: LG Electronics Inc.

(21) Appl. No.: 10/288,474

(22) Filed: Nov. 6, 2002

(30) Foreign Application Priority Data
Nov. 30, 2001 (KR) 75326/2001

(51) Int. Cl. G01R 31/08

(52) U.S. Cl. 370/230; 370/235

(57) ABSTRACT

A congestion avoidance apparatus includes a reception unit which receives a packet from an input link, a transmission unit which transmits the packet from the reception unit to an output link, a buffer which temporarily stores the packet before being transmitted, a switching unit for routing the packet from the reception unit to the transmission unit, and a controller for controlling the reception unit, transmission unit, buffer, and switching uni. The transmission unit includes a RED/WRED module which determines whether or not to enable a RED/WRED function, based on a traffic type and more specifically a protocol type of the packet. This is accomplished by determining whether or not an upper layer protocol of the packet is TCP, enabling the RED/WRED function if the upper layer protocol is TCP, disabling the RED/WRED function if the upper layer protocol is not TCP, and then storing the packet in a corresponding queue.

### BACKGROUND OF THE INVENTION

1. Field of the Invention

The present invention generally relates to communication networks, and in particular to an enhanced congestion avoidance apparatus and method for a communication network.

2. Background of the Related Art

A communication network may be described as a collection of end systems interconnected through one or more routers. The end systems communicate data with each other on the communication network. Typically, the end systems act as both sources and destinations depending on whether they are sending or receiving data.

A source sends data in the form of packet over a communication link to a router, known as a gateway, which connected to other routers over other communication links. The router is a switching element which processes the packets by transferring the packets arriving over one link to another link for transmission to a destination terminal or another router.

Congestion can occur when multiple input streams arrive at a router whose output capacity is less than the sum of the inputs. Congestion avoidance is a way to deal with lost packets.

Congestion avoidance works with “slow start” to try to avoid packet discards. Slow start is a method of slowing the increase in transmission rate when congestion occurs.

Old TCPs would start a connection with the sender injecting multiple segments into the network, up to the window size advertised by the destination. While the window size is OK when the sender and receiver are on the same LAN, if there are routers and slower links between the sender and the receiver problems can arise. Some intermediate router must queue the packets, and it is possible for the router run out of space, resulting in a drastic reduction of throughput of a TCP connection.

The sender starts by transmitting one segment and waiting for its ACK. When that ACK is received, a congestion window is incremented from one to two, and two segments can be sent. When each of those two segments is acknowledged, the congestion window is increased to four. This provides an exponential growth, although it is not exactly exponential because the receiver may delay its ACKs.

Congestion avoidance is achieved through packet dropping. Among the more commonly used congestion avoidance mechanisms is Random Early Detection (RED), which is optimum for high-speed networks. RED takes advantages of TCP's congestion control mechanism. By randomly dropping packets prior to periods of high congestion, RED tells the packet source to decrease its transmission rate. Assuming the packet source is using TCP, it will decrease its transmission rate until all the packets reach their destination, indicating that the congestion is cleared. TCP not only pauses, but it also restarts quickly and adapts its transmission rate to the rate that the network can support.

RED begins dropping packets when congestion occurs at a rate selected during configuration. A packet drop probability is based on the minimum threshold, maximum threshold, and mark probability denominator. When the average queue depth is above the minimum threshold, RED starts dropping packets. The rate of packet drop increases linearly as the average queue size increases until the average queue size reaches the maximum threshold.

When RED is not used, output buffers fill during periods of congestion. When the buffers are full, tail drop occurs such that all additional packets are dropped. Since the packets are dropped all at once, global synchronization of TCP hosts can occur as multiple TCP hosts reduce their transmission rates.

RED reduces the chances of tail drop by selectively dropping packets when the output interface begins to show signs of congestion. By dropping some packets early rather than waiting until the buffer is full, RED avoids dropping large numbers of packets at once and minimizes the chances of global synchronization. Thus, RED allows the transmission line to be used fully at all times.

Weighted RED (WRED) combines the capabilities of the RED algorithm with IP Precedence to provide for preferential traffic handling of higher priority packets. WRED generally drops packets selectively based on IP precedence. Packets with a higher IP precedence are less likely to be dropped than packets with a lower precedence. Thus, high priority traffic is delivered with a higher probability than lower priority traffic.

RED/WRED differs from other congestion avoidance techniques such as queuing strategies because it attempts to anticipate and avoid congestion rather than control congestion once it occurs. Furthermore, WRED provides separate thresholds and weights for different IP precedence. This allows different qualities of service to be provided in regard to packet dropping for different traffic types. Standard traffic may be dropped more frequently than premium traffic during periods of congestion.

However, RED/WRED is only useful when the bulk of the traffic is TCP/IP traffic. With TCP, dropped packets indicate congestion, so the packet source will reduce its transmission rate. With other protocols, packet sources may not respond or may resend dropped packets at the same rate. Thus, dropping packets does not decrease congestion.

Also, WRED treats non-IP (or non-TCP) traffic as precedence 0, the lowest precedence. Therefore, non-IP traffic (or non-TCP), in general, is more likely to be dropped than IP traffic.

### SUMMARY OF THE INVENTION

An object of the invention is to solve at least the above problems and/or disadvantages and to provide at least the advantages described hereinafter.

It is an object of the present invention to provide a congestion avoidance apparatus and method for a communication network which enhances network performance by dynamically activating RED/WRED according to a protocol type of packets.

To achieve this and other objects, the congestion avoidance apparatus of the present invention comprises a reception unit receiving a packet arriving over an input link, a transmission unit transmitting the packet from the reception unit over an output link, a buffer temporarily storing the packet before being transmitted, a switching unit for routing the packet from the reception unit to the transmission unit, and a controller for controlling the reception unit, transmission unit, buffer, and switching unit. The transmission unit includes a RED/WRED module for determining whether or not to enable RED/WRED function. The RED/WRED module comprises a protocol type discriminator for checking a type of upper layer protocol and an RED/WRED controller for enabling or disabling the RED/WRED function according to the type of upper layer protocol. The protocol type discriminator tags a flag set to a first value if the type of the upper layer protocol is TCP. The flag is set to a second value if the type of the upper layer protocol is not TCP. The RED/WRED controller enables the RED/WRED function if the flag is set to the first value and disables the RED/WRED function if the flag is set to the second value.

The congestion avoidance method of the present invention comprises the steps of receiving a packet over an input link, determining whether or not an upper layer protocol of the packet is TCP, enabling RED/WRED function if the upper layer protocol is TCP, and inputting the packet to a corresponding queue. The method further comprises disabling the RED/WRED function if the upper layer protocol is not TCP. The step of the upper layer protocol type determination includes checking a protocol field of a packet header of the packet, and tagging the packet with a flag indicating the upper layer protocol. The flag is set to 1 if the upper layer protocol is TCP and set to 0 if the upper layer protocol is not TCP. The RED/WRED enabling step includes determining whether or not an average queue size is greater than a threshold value and discarding the packet if the average queue size is greater than the threshold value.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic view illustrating a congestion avoidance apparatus according to a preferred embodiment of the present invention;

FIG. 2 is a drawing illustrating IP packet; and

FIG. 3 is a flowchart illustrating a congestion avoidance method according to the preferred embodiment of the present invention.

### DETAILED DESCRIPTION OF PREFERRED EMBODIMENTS

Generally speaking, data services over a network can be classified into reliable and unreliable services based on data characteristics of upper layer applications, and this classification may help reduce network traffic.

For example, TCP/IP supports two transport layer protocols, namely, a transport control protocol (TCP) and user datagram protocol (UDP). The TCP provides reliable connection-oriented service for applications critically requiring reliability such as file transfer protocol (FTP), hypertext transfer protocol (HTTP), simple mail transport protocol (SMTP), and etc. On the other hand, the UDP provides unreliable connectionless service for applications requiring relatively low reliability such as domain name system (DNS), trivial file transfer protocol (TFTP), and etc. so as to avoid traffic caused by retransmission which is a TCP function to guarantee reliable transmission.

Recently, various techniques for supplementing disadvantages of the flow control, which is inevitable for reliable data transmission, have been developed and most of these techniques anticipates and avoids congestion. However, routers are likely to adapt these congestion avoidance polices to all kinds of traffic including both reliable and unreliable data traffic. This wastes processing time because the unreliable data traffic does not require flow control.

The present invention overcomes these and other drawbacks by using a router which discriminates between reliable service traffic and unreliable traffic and more specifically which selectively adapts a congestion avoidance function to reliable service traffic. The present invention will now be described with reference to the accompanying drawings, exemplary with TCP/IP.

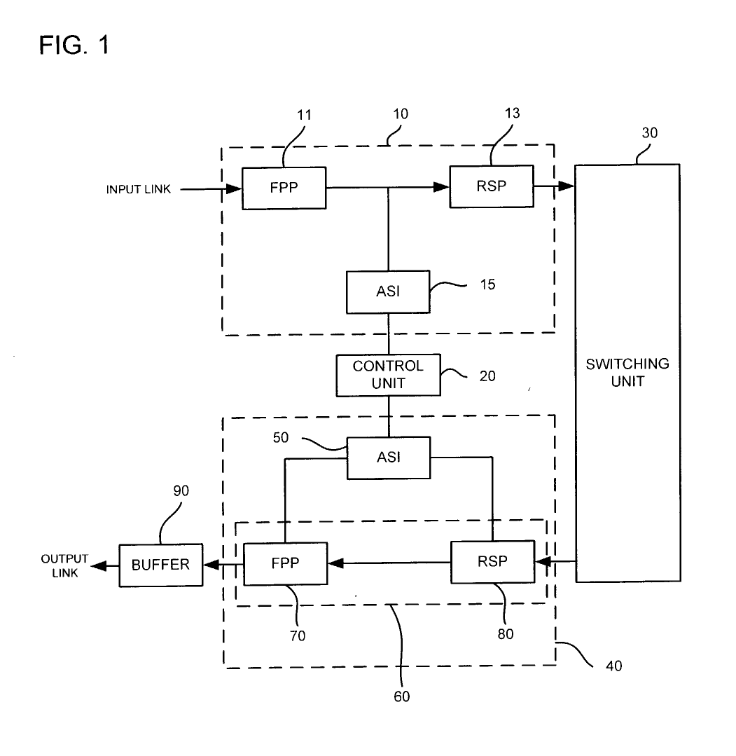

FIG. 1 shows an apparatus for performing congestion avoidance in accordance with one embodiment of the present invention. This apparatus includes a reception unit 10, a transmission unit 40, a switching unit 30 for routing IP packets received by the reception unit to the transmission unit 40, a buffer 90 connected to an output port of the transmission unit, and a control unit 20 connected to the reception unit and the transmission unit. The reception unit and the transmission unit communicate with the control unit via respective monitoring units 15 and 50. The monitoring units may be in the form of Agere system interfaces (ASI)

The reception unit 10 is connected to an input link for receiving IP packets, and the packets are sent to the switching unit 30 via a fast pattern processor (FPP) 11 and a routing switch processor (RSP) 13 within the reception unit. The switching unit 30 routes the packets received from the reception unit to the transmission unit, and the transmission unit 40 stores the packet in the buffer 90 according to routing information in the IP packet before being transmitted to a destination over an output link. The control unit 20 preferably controls the processes of the reception unit, transmission unit, and the switching unit.

The transmission unit 40 includes a monitoring module 50 and a RED/WRED module 60 having a protocol type discriminator 80 and RED/WRED controller 70. The monitoring module 50 manages the RED/WRED module 60 under control of the control unit 20, counts the number of packets injected into the RED/WRED module 60, and monitors traffic flow for guaranteeing QoS negotiated during a connection establishment.

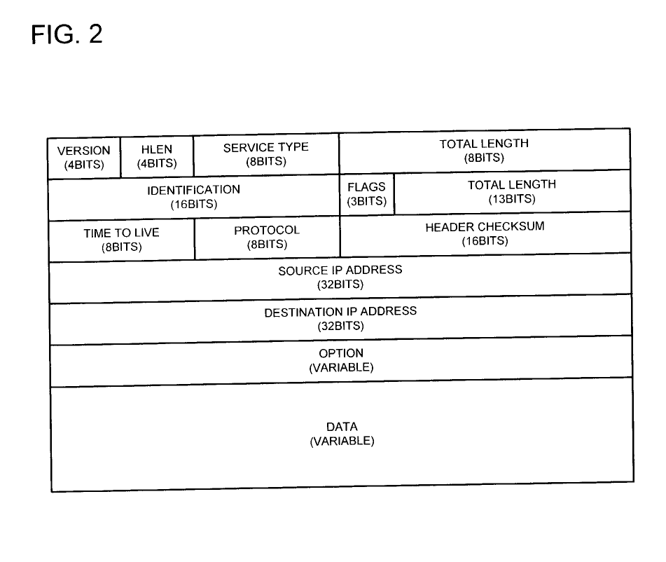

The protocol type discriminator 80 of the RED/WRED module discriminates the type of another (e.g., an upper) layer protocol by reading a protocol field (PROTOCOL) of the packet from the switching unit 30. (See FIG. 2). The protocol type discriminator tags a flag set to 1 to the packet if the protocol is TCP and tags a flag set to 0 if the protocol is not TCP.

The RED/WRED controller 70 determines whether or not to enable the RED/WRED function based on the flag set by the protocol type discriminator. If the flag is set to 1, the RED/WRED controller 70 enables the RED/WRED function, and if the flag is set to 0, the RED/WRED controller 70 disables the RED/WRED function.

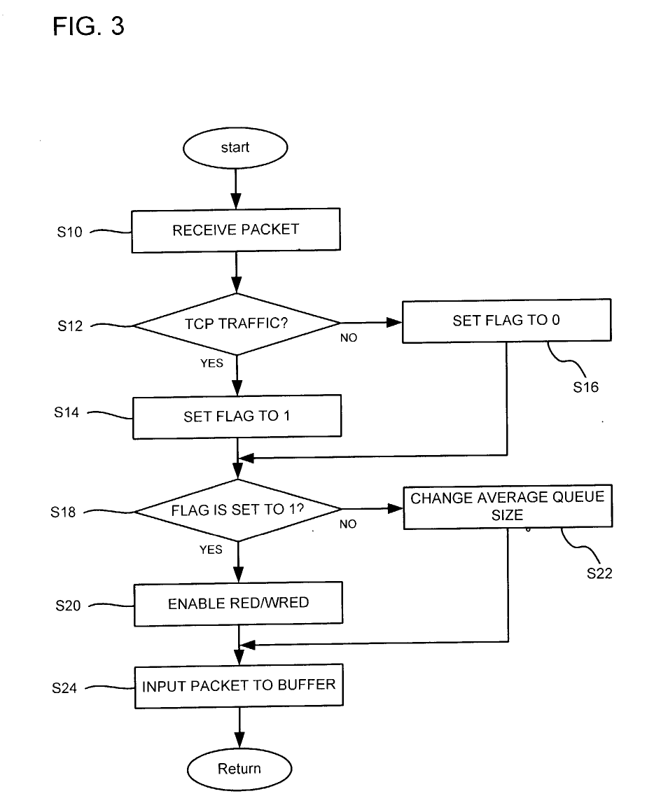

FIG. 3 shows steps included in one embodiment of a method for performing congestion avoidance in accordance with the present invention. Once transmission unit 40 receives an IP packet from the switching unit 30 at step S10, the protocol type discriminator 80 determines whether or not the type of the upper layer protocol is TCP (or IP) by reading a protocol field of the IP packet header at step S12.

If it is determined that the upper layer protocol is TCP, the protocol type discriminator sets the flag to 1 at step S14 and send the packet to the RED/WRED controller 70. On the other hand, if the upper layer protocol is not TCP, the protocol type discriminator sets the flag to 0 at step S16.

Upon receiving the packet from the protocol type discriminator 80, the RED/WRED controller determines whether or not to enable the RED/WRED function based on the value of the flag at step S18.

If the flag is set to 1, the RED/WRED controller 70 enables the RED/WRED function at step S20 and inputs the packet to buffer 90. Otherwise, if flag is set to 0, the RED/WRED controller 70 increases an average queue size without enabling the RED/WRED function, at step S22.

Enabling the RED/WRED at step S20 avoids dropping large numbers of packets at once and minimizes the chances of global synchronization. That is, if RED is enabled, the congestion avoidance apparatus determines whether or not an average queue size of the buffer 90 to which the packet received at step S10 is input is greater than a threshold value. If it is determined that the average queue size is greater than the threshold value, the packet is discarded. Otherwise, the packet is stored in the buffer.

In case the WRED is enabled, the congestion avoidance apparatus determines whether or not the average queue size of the buffer 90 to which the packet received at step S10 is input is greater than a threshold value, which is calculated based on the IP precedence or DSCP value of the received packet. If it is determined that the average queue size is greater than the threshold value, the packet is discarded. Otherwise, the packet is stored in the buffer so as to be transmitted over the output link.

At step S18, if it is determined that the RED/WRED function should be disabled, the congestion avoidance apparatus changes the average queue size at step S22 and the packet is stored in the buffer 90 at step S24. The reason why the average queue size is changed at step S22 even when the packet is not the TCP traffic is to adapt the RED/WRED with accurate average queue size to the next TCP traffic to be received.

In summary, the congestion avoidance apparatus of the present invention reads the protocol field of an input TP packet so as to enable the RED/WRED function only when the upper layer protocol is TCP. Moreover, the average queue size of an output buffer is changed by disabling the RED/WRED function only for traffic of other (e.g., non-TCP) protocols. As a result, it is possible to dynamically control traffic flow based on the protocol type of upper layer.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A congestion avoidance apparatus, comprising:
a reception unit which receives a packet from an input link;
a transmission unit which-transmits the packet from the reception unit over an output link, the transmission unit having a RED/WRED module for determining whether or not to enable a RED/WRED function;
a buffer which stores the packet before being transmitted;
a switching unit for routing the packet from the reception unit to the transmission unit; and
a controller for controlling the reception unit, transmission unit, buffer, and switching unit.

2. The congestion avoidance apparatus of claim 1, wherein the RED/WRED module comprises:
a protocol type discriminator which determines a type of protocol of the packet; and
a RED/WRED controller for enabling or disabling the RED/WRED function based on the type of protocol determined by the protocol type discriminator.

3. The congestion avoidance apparatus of claim 2, wherein the protocol type discriminator tags a flag set to a first value if the upper layer protocol is TCP and tags the flag set to a second value if the type of the upper layer protocol is not TCP.

4. The congestion avoidance apparatus of claim 3, wherein the RED/WRED controller enables the RED/WRED function if the flag is set to the first value and disables the RED/WRED function if the flag is set to the second value.

5. A congestion avoidance method, comprising:
receiving a packet over an input link;
determining whether or not an upper layer protocol of the packet supports flow control; and
activating a congestion avoidance function when the upper layer protocol supports flow control.

6. The congestion avoidance method of claim 5, further comprising:
disabling the congestion avoidance function when the upper layer protocol does not support flow control.

7. The congestion avoidance method of claim 6, wherein the packet is an internet protocol (IP) packet.

8. The congestion avoidance method of claim 7, wherein the upper layer protocol is a transmission control protocol (TCP) or a user datagram protocol (UDP).

9. The congestion avoidance method of claim 8, wherein the upper layer protocol determination step includes:
checking a protocol type field in a header of the packet; and
tagging a flag to the packet indicating the upper layer protocol.

10. The congestion avoidance method of claim 9, wherein the flag is set to a first value when the upper layer protocol is TCP.

11. The congestion avoidance method of claim 10, wherein the flag is set to a second value when the upper layer protocol is not TCP.

12. A congestion avoidance method, comprising:
receiving a packet over an input link;
determining whether or not an upper layer protocol of the packet is TCP;
enabling a RED/WRED function if the upper layer protocol is TCP; and
storing the packet in a buffer.

13. The congestion avoidance method of claim 12, further comprising:
disabling the RED/WRED function if the upper layer protocol is not TCP.

14. The congestion avoidance method of claim 13, wherein the determining step includes:
checking a protocol field in a header of the packet; and
tagging the packet with a flag indicating the upper layer protocol.

15. The congestion avoidance method of claim 14, wherein the flag is set to a first value if the upper layer protocol is TCP.

16. The congestion avoidance method of claim 14, wherein the flag is set to a second value if the upper layer protocol is not TCP.

17. The congestion avoidance method of claim 12, wherein the RED/WRED enabling step includes:
determining whether or not an average queue size is greater than a threshold value; and
discarding the packet if the average queue size is greater than the threshold value.

18. A congestion avoidance method, comprising:
receiving a packet over an input link;
determining whether or not an upper layer protocol of the packet is TCP;
enabling a RED/WRED function if the upper layer protocol is TCP;
disabling the RED/WRED function if the upper layer protocol is not TCP; and
storing the packet in a buffer.

19. The congestion avoidance method of claim 18, wherein the upper layer protocol determination step includes:
checking a protocol field in a header of the packet; and
tagging the packet with a flag set to a first value if the upper layer protocol is TCP; and
tagging the packet with the flag set to a second value if the upper layer protocol is not TC.

20. The congestion avoidance method of claim 19, wherein the RED/WRED enabling step includes:
determining whether or not an average queue size is greater than a threshold value; and
discarding the packet if the average queue size is greater than the threshold value.

21. The congestion avoidance apparatus of claim 2, wherein the protocol is an upper layer protocol.

22. A method for controlling traffic flow in a network, comprising:
determining a protocol type of a received packet; and
performing a congestion avoidance function based on a result of the determining step.

23. The method of claim 22, wherein the performing step includes:
performing one of a RED function and a WRED function when the protocol type of the received packet is an upper layer protocol.

24. The method of claim 23, wherein the upper layer protocol is one of a transmission control protocol (TCP) and a user datagram protocol (UDP).

25. The method of claim 23, further comprising:
comparing an average queue size of an output buffer to a threshold value; and
discarding the packet based on a result of the comparing step.

26. The method of claim 25, wherein the threshold value is based on one of an IP precedence and a DSCP value of the received packet.

27. The method of claim 23, wherein the performing step includes:
disabling a congestion avoidance function when the protocol type of the received packet is not one of a transmission control protocol (TCP) and a user datagram protocol (UDP); and
storing the packet in a buffer.

28. The method of claim 27, wherein the disabled congestion avoidance function is one of a RED function and a WRED function.

29. The method of claim 28, further comprising:
increasing an average queue size of the buffer
